(19) United States
(12) Patent Application Publication
(10) Pub. No.: US 2001/0012304 A1
(43) Pub. Date: Aug. 9, 2001

(54) HIGH QUALITY MULTIMEDIA COMMUNICATIONS `

(75) Inventors: SANJAY AGRAHARAM, MARLBORO, NJ (US); VIJAY K. BHAGAVATH, LINCROFT, NJ (US); JOSEPH GOLAN, OCEAN, NJ (US); MICHAEL W. HODIC, SPRINGFIELD, NJ (US); RAM S. RAMAMURTHY, MANALAPAN, NJ (US)

Correspondence Address: OLIFF & BERRIDGE, PLC, P.O. BOX 19928, ALEXANDRIA, VA, 22320

(73) Assignee: AT&T CORP.

(21) Appl. No.: 08/967,928

(22) Filed: Nov. 12, 1997

(51) Int. Cl. H04J 3/26

(52) U.S. Cl. 370/487; 370/535

(57) ABSTRACT

A method of providing high quality multimedia communications between end users uses an ATM-ADSL access system, which provides 6 megabits per second downstream and 640 kilobits per second upstream multimedia signal in conjunction with a multicasting feature. An end user can receive multiple video/audio streams downstream while the end user's video/audio is transmitted upstream to the multicast network and is multicast to the end points.

### BACKGROUND OF THE INVENTION

1. Field of Invention

This invention relates to multimedia communications. More particularly, this invention relates to a method and an apparatus for providing high quality multimedia calls involving voice, video, and data, between end users having different communications capabilities including residential end users.

2. Description of Related Art

Some of the characteristics of face-to-face meetings can be simulated by conventional multimedia conferencing systems. Such conferencing systems permit separated conference participants to communicate with each other in multimedia. Working with multimedia allows the participants to create, edit, transmit, receive, store, compute and delete two or more types of information including data, text, vector graphics, pixel-based images, video signals and audio signals. The conference participants need not be in the same place to receive the multimedia communications.

Some conferencing systems use multimedia computer workstations connected together by a single type of transmission facility such as an integrated subscriber digital network (ISDN), which acts as a transport mechanism for the communications between the workstations. Other conventional multimedia systems use standard telephones in a specially configured multimedia communications network. Still other multimedia systems allow some participants to use a subset of the multimedia types (e.g., data and text). These networks provide shared multimedia communications that are readily accessible to subscribers of the service provided by the network. Subscribers access these services using integrated access mechanisms such as N-ISDN, ATM and B-ISDN access mechanism for all media, or separated non-integrated access through distinct networks for different media.

While the above networks have made multimedia services more available for commercial subscribers, the use of multimedia in other areas, particularly residential uses, is still limited. This is because existing telephone lines do not have the capacity, or bandwidth, to allow full multimedia conferencing among a number of subscribers, when those subscribers must, at least in part, rely on residential telephone lines and conventional multimedia systems.

### SUMMARY OF THE INVENTION

In view of the above limitations of providing multimedia services, particularly to residential subscribers, it is an object of this invention to provide a method for providing high quality multimedia calls to end users. In particular, it is an object of the invention to provide this method to both residential and non-residential subscribers.

In one aspect of the invention, multimedia services, for example, a multimedia call, may be provided to subscribers to a multimedia service using a multicast-capable network and asymmetric digital subscriber line (ADSL) connections. In the discussion that follows, the multimedia call will refer to audio, video and data signals. However, this should be understood to include all forms of multimedia.

The multicast-capable network may include audio, video, and data bridges. An ADSL connection may provide a lower bandwidth for signals transmitted upstream from a subscriber to the multicast-capable network and a higher bandwidth for signals transmitted downstream from the multicast-capable network to the subscriber. Further, the multicast-capable network may allow a subscriber to transmit upstream, using only one signal line, and the multicast-capable network may then multicast, or simultaneously transmit, all the signals from each subscriber to all of the other subscribers engaged in the multimedia call. As a result, a subscriber may be able to receive high quality multimedia from several different subscribers, and may be able to use the full upstream bandwidth to provide high quality signals to the multicast-capable network.

In another aspect of the invention, some subscribers may be connected to the multicast-capable network using the ADSL connections. Some subscribers may be connected to each other by a local area network (LAN) and may be connected to other subscribers by the multicast-capable network. As a result, some subscribers may transmit multimedia communications, including video and data, to each other through the local area network connections and transmit the same signals to the other subscribers using the multicast-capable network.

Creating a multimedia call between one or more subscribers may start with one subscriber placing a call to the multicast-capable network. The subscriber may then ask the multicast-capable network to create a virtual meeting room in the multicast-capable network. A virtual meeting room is an electronic analog of an actual meeting room where face-to-face conferences are held. The virtual meeting room may be controlled by an adjunct to the multicast-capable network, such as a virtual meeting services complex. The virtual meeting room may be controllably persistent, that is, the virtual meeting room may be maintained in the multicast-capable network even after all subscribers have gone on-hook or otherwise terminated their connection to the multimedia call. The subscribers may come and go with respect to the multimedia calls held in the virtual meeting room. Because the virtual meeting room can be retained in the network for an indefinite period of time, the subscribers, either individually or as a group, may return to the virtual meeting room to continue the multimedia call or to review some aspect of the multimedia call.

Once the virtual meeting room is established, the virtual meeting services complex may associate the subscriber with the virtual meeting room and establish an association with one or more other subscribers in the virtual meeting room. The subscribers may then transmit multimedia from each subscriber to the multicast-capable network. Then, the multicast-capable network may multicast the multimedia received from each subscriber so that each subscriber is able to receive multimedia communications from all other subscribers that are joined in the multimedia call.

Other methods for initiating the multimedia call are also available. For example, all participants in the multimedia call may first dial in to a meet-me-bridge. Alternately, the multicast-capable network may initiate the call to all the participants.

In another example of the multimedia service, two or more subscribers of the multimedia service may be connected together by a LAN. For example, two subscribers connected by the LAN may transmit multimedia to each other through the LAN. However, the two subscribers may transmit and receive multimedia to and from other subscribers by using ADSL connections to the multicast-capable network. The multimedia is then multicast to all the other subscribers connected by the asymmetric digital subscriber line connections to the multicast-capable network.

### BRIEF DESCRIPTION OF THE DRAWINGS

The invention is described in detail with reference to the following drawings, wherein like numerals refer to like elements, and wherein:

FIG. 1 is an example of a multicast-capable network in accordance with this invention;

FIG. 2 shows the subscriber computer;

FIG. 3 shows a videophone;

FIG. 4 is a circuit diagram illustrating the network shown in FIG. 1;

FIG. 5 is a schematic of a virtual meeting room;

FIG. 6 is another example of a multicast network in accordance with this invention; and

FIGS. 7A-9 are flowcharts representing the operation of the multicast network shown in FIG. 1.

### DETAILED DESCRIPTION OF PREFERRED EMBODIMENTS

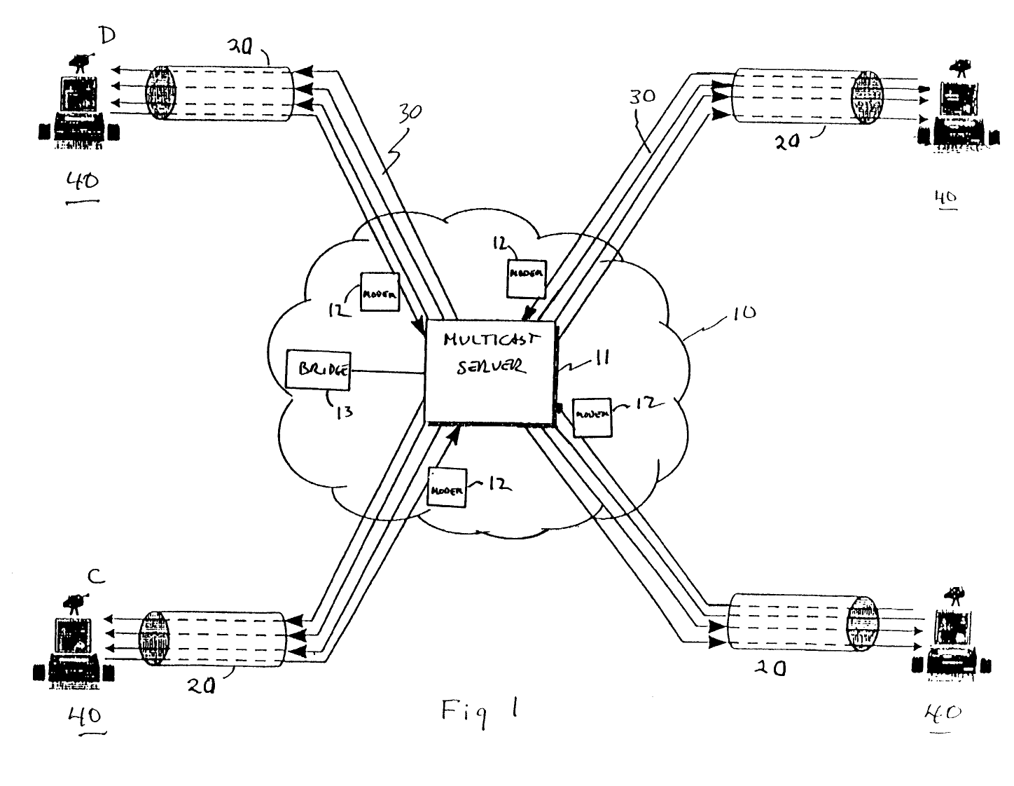

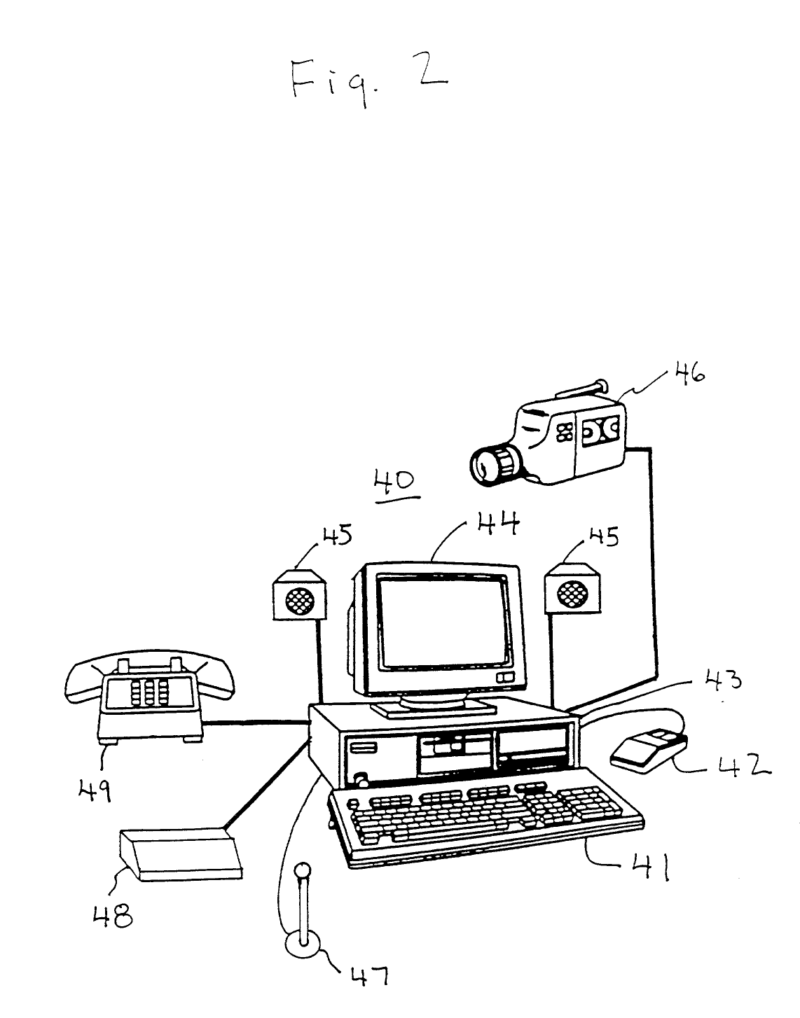

FIG. 1 is an example of the multicast-capable network in accordance with the invention used to provide high quality multimedia services to subscribers. The multicast-capable network may be a conventional network, such as a publicly switched telephone network (PSTN) that contains a bridge that takes responsibility for sending the multimedia communications as many times as needed to complete the multimedia call. Alternately, the multicast-capable network may be a dedicated multicast network that receives and transmits full bandwidth using a multicast server. In the discussion that follows, the term multicast network will be used, and should be understood to apply to any network capable of multicasting signals.

In FIG. 1, subscribers A-D connect to a multicast network 10 via asymmetric digital subscriber line (ADSL) connections 20 and lines 30. The ADSL connections allow a bandwidth of 640 kilobits per second (kb/s) for signals transmitted upstream from each subscriber A-D to the multicast network 10. However, the ADSL connections allow a bandwidth of 6 megabits per second (mb/s) for signals sent downstream from the multicast network 10 to each of the subscribers A-D. FIG. 1 shows four subscribers A-D, and the discussion that follows assumes a multimedia call takes place among subscribers A-D. However, the invention is not limited to four subscribers, and more subscribers may be added, as long as the ADSL bandwidth limit of 6 mb/s downstream is satisfied. The actual number of subscribers who can participate in the multimedia call is limited by considerations such as the amount of bandwidth required to provide a high quality signal. For example, a high quality video signal of 30 frames per second (fps) or more requires a bandwidth of about 400 kb/s. Thus, as many as fifteen or more subscribers can be actively engaged in a multimedia call according to the method of the invention.

In FIG. 1, subscribers A-D connect to the multicast network 10 over existing telephone lines using asynchronous transfer mode (ATM) protocols and ADSL connectors 20 and computers 40. Alternately, the multimedia call could use an Ethernet or any backbone network capable of providing a high bandwidth. The method for providing the multimedia call could also operate over the public Internet (non-ATM) and a public switched telephone network (PSTN), for example. However, to achieve the highest quality multimedia communications, the method of the invention is best executed using ADSL access technology with ATM protocols.

The multicast network 10 includes a multimedia communications device such as a multicast server or a bridge. If the bridge is used, the bridge may repeatedly transmit the multimedia communications, one transmission for each subscriber connected in the multimedia call. A multicast server may transmit the multimedia communications simultaneously to each of the subscribers. In the discussion that follows, a multicast server 11 controls the multimedia call among the subscribers A-D and modems 12 receive digital signals from the subscribers A-D. The multicast server 11 may also include an audio bridge 13. By using a dedicated server, the method of the invention can ensure high quality multimedia and can control access to the multimedia call so that only authorized subscribers can participate. In operation, the multicast server 11 receives multimedia from all the subscribers and retransmits the multimedia to all the subscribers. For example, the multicast server 11 receives multimedia including audio, video and data from subscribers A-D. The multicast server 11 would then simultaneously retransmit, or multicast, the multimedia from subscribers B-D to subscriber A, the multimedia from subscribers A, C and D to subscriber D, the multimedia from subscribers A, B and D to subscriber C and the multimedia from subscribers A-C to subscriber D. Alternately, the multicast server 11 may multicast only the video and data signals, or may multicast only one of the multimedia signals.

The lines 30 are standard telephone lines that normally allow a 64 kb/s telephone call. However, when the lines 30 are conditioned by an ADSL modem such as the modem 48 shown in FIG. 2, higher bandwidth signals can be sent. The lines 30 that are conditioned by the modem 48 are called digital subscriber lines. The modem 48 sends a digital signal over the line 30 to the multicast network 10 where the digital signal is received by the modem 12. The lines 30 are shown in FIG. 1 as three lines downstream and one line upstream. However, this configuration is for illustration only, and does not reflect actual line construction. As noted above, the lines 30 are standard lines used in telephone communication systems.

FIG. 2 shows more detail of the communications devices including the computer 40 available to each subscribers A-D. The computer 40 includes a data entry device such as a keyboard 41 and a mouse 42, a central processor unit (CPU) 43, a visual display 44, speakers 45, a video camera 46 and a microphone 47. The portable computer 40 may also include the modem 48. However, the modem 48 can be a stand-alone device as shown in FIG. 2. Furthermore, the modem 48 is not always necessary for multimedia communications according to the invention. For example, if two or more subscribers are connected by a local area network (LAN) the modem 48 is not needed for those subscribers. The computer may be connected to a telephone 49. The computer 40 may be a personal computer, a portable computer, a workstation or a mainframe computer.

The microphone 47 may be supplied separately and connected to the personal computer 40 and may be incorporated into the telephone 49. The video camera 46 is used to capture and transmit an image of each subscriber A-D. The image output from the video camera 46 is first sent to a codec (not shown) before it is transmitted to the multicast network 10. The speakers 45 provide audio signals from the subscribers A-D. The display 44 may display images of the subscribers A-D. The display 44 may also display information related to the multimedia call such as a call label, and tool bars that allow the subscribers to interact with the multicast server 11 in the multicast network 10. The computer 40 is loaded with a specific application program that allows the subscriber to interface with the multicast server 11 and other network components. The keyboard 41 and the mouse 42 function as data input devices that allow the subscriber to send commands to the client server 11, for example. The CPU 43 controls all functions of the computer 40.

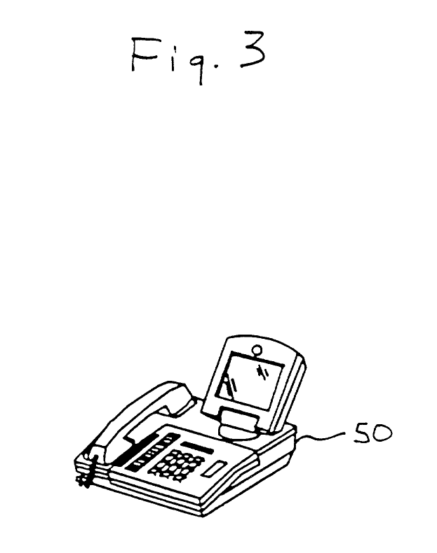

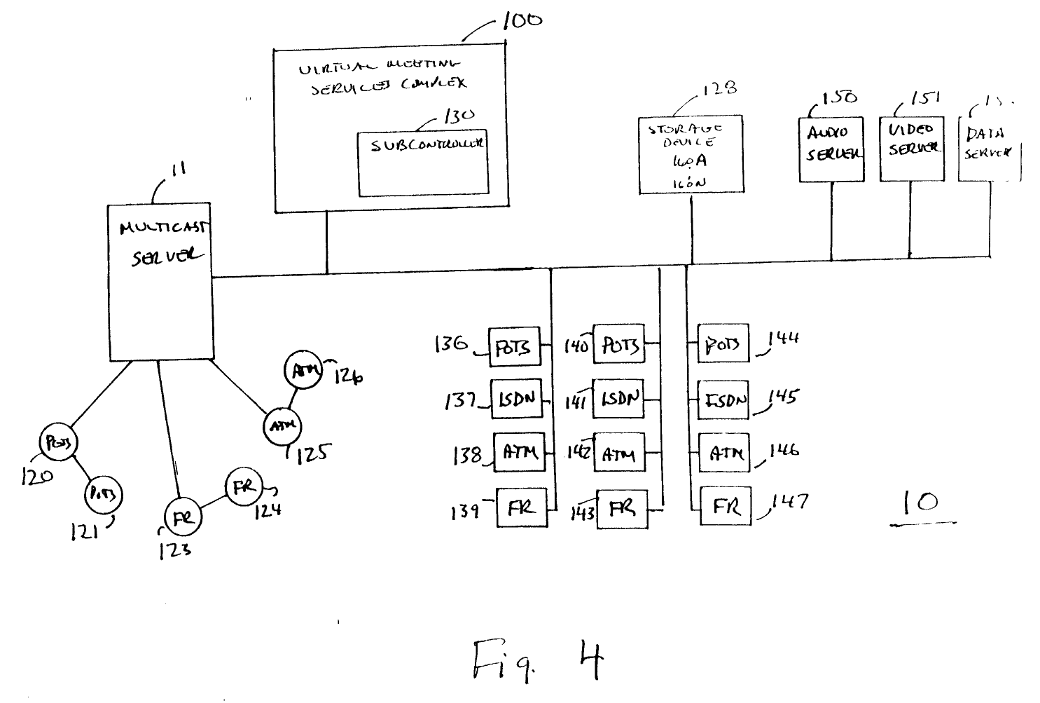

The subscribers may also be able to communicate multimedia using other communications devices. For example, FIG. 3 shows a videophone 50 that can be used to connect subscribers to the multicast network 10.

Returning to FIG. 1, all communications between subscribers A-D pass through the multicast network 10. That is, the multimedia, audio, video and data signals from subscriber A, for example, are transmitted upstream (at a maximum bandwidth of about 640 kb/s) to the multicast network 10. The multimedia from subscriber A may then be multicast to each of the subscribers B-D. In the example shown in FIG. 1, each subscriber A-D receives multimedia audio, video, and data signals from the other three subscribers. For example, subscriber A receives multimedia from subscribers B-D. Because the downstream bandwidth limit is about 6 mb/s, even if subscribers B-D transmit a full 640 kb/s signal, subscriber A will receive all of the multimedia signals from subscribers B-D.

While FIG. 1 shows all four subscribers A-D sending and receiving multimedia audio, video, and data communications, this invention does not require compatibility of equipment between the subscribers A-D. Thus, subscriber A may not have the video camera 46, for example. In that case, subscriber A could then only transmit audio and data communications. Further, the modems 48 need not be rated at the same speed, and the computers 40 need not be compatible, for example. Still further, some subscribers, such as subscribers A and B, may be able to transmit compressed audio, for example, but receive uncompressed audio. Many other combinations of equipment configuration are also possible.

FIG. 1 shows the subscribers A-D connected to multicast network 10 using computers. However, some subscribers can connect to the multicast network 10 using the telephone 49 shown in FIG. 2 or the videophone 50 shown in FIG. 3, or a cellular phone (not shown), for example, to transmit and receive selected multimedia signals.

Video and data signals arriving at the multicast network 10 are coupled to the multicast server 11. The multicast server 11 takes the video and data signals input from one subscriber, such as subscriber A, and multicasts them to a number of different subscribers. For example, when subscriber A transmits multimedia to the multicast network 10, the video and data signals are then multicast by the multicast network 10 to the subscribers B-D.

In general, video signals may be supplied from each subscriber to the multicast server 11 during the duration of the multimedia call. However, a subscriber, such as subscriber C, can direct the multicast server 11 not to send the subscriber C video signal to subscriber D, for example. Alternately, subscriber C can disable all video signals from subscriber C by either directing the multicast server 11 not to transmit the subscriber C video signal, or by turning off the subscriber C video camera 46.

Data signals are transmitted to the multicast network 10 on an as needed basis. For example, subscriber A can send a spreadsheet to the multicast server 11 and the multicast server 11 will transmit the data signal to subscribers B-D. Subscribers B-D may receive the data signal in a download file created by the specific application program running on the computer 40, for example. The data can also be displayed on the display 44.

Audio signals may also be multicast. However, multicasting audio signals unnecessarily uses bandwidth. Accordingly, audio signals may be supplied to the bridge 13. The audio signals are mixed in the bridge 13 and may then be supplied to all the subscribers A-D as one audio signal with a bandwidth of 80 kb/s, for example.

FIG. 1 shows one multicast network 10. However, the method for providing high quality multimedia calls according to the invention is equally applicable when there are several multicast networks 10. Thus, the first multicast network 10 could receive a multimedia signal from subscriber A, for example, and multicast the multimedia signal to several other subscribers and to a second multicast network. The second multicast network could then transmit the multimedia signal to several additional subscribers. Furthermore, one or more multicast servers 11 may be used to allow a subscriber such as subscriber C to participate in more than one multimedia call. Thus, subscriber C may participate in the multimedia call among subscribers A-D and may also simultaneously participate in a second multimedia call among other subscribers. The multimedia transmitted from subscriber C is multicast to the two different groups of multimedia call participants either by one or more multicast servers 11. The multicast signals provided from the one or more multicast servers 11 are transmitted through the ADSL connection 20 shown in FIG. 1 and are sent to the computer 40, for example.

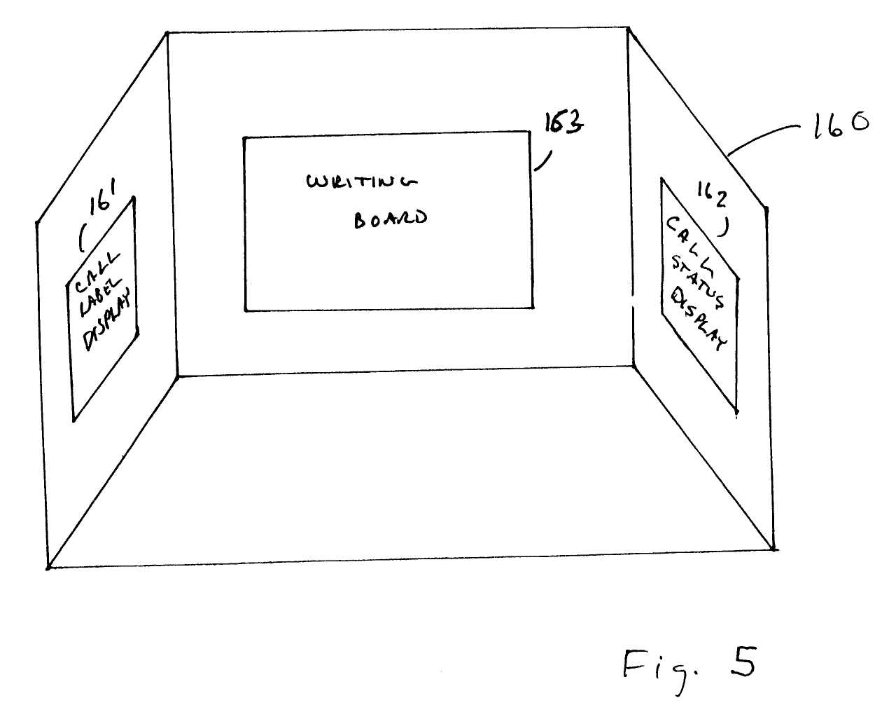

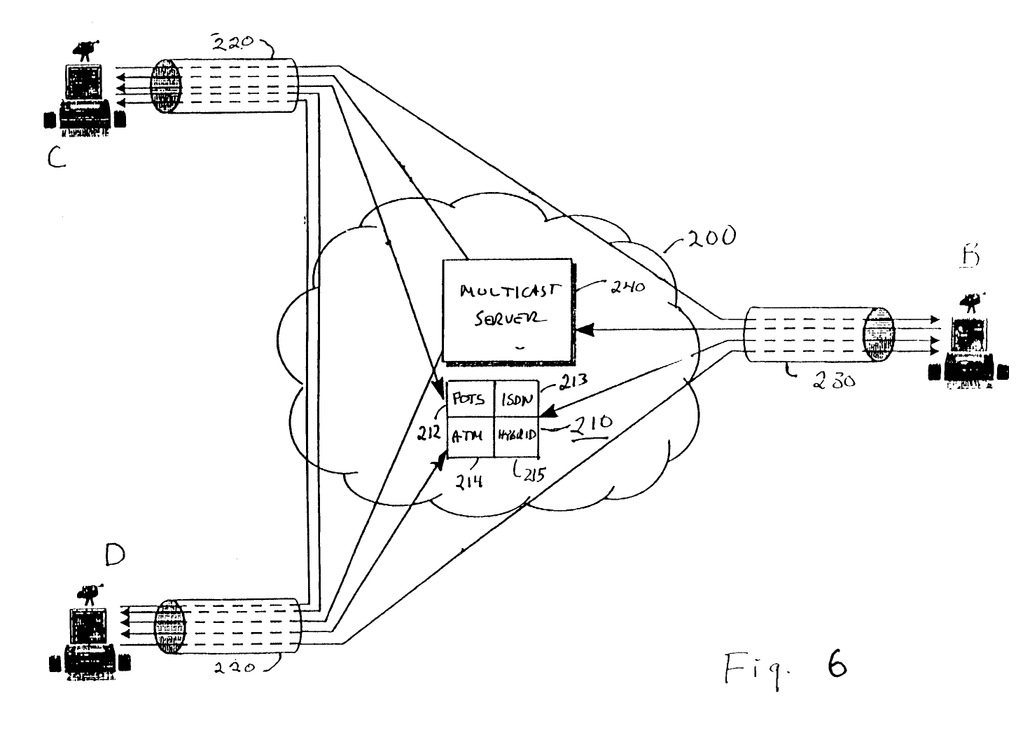

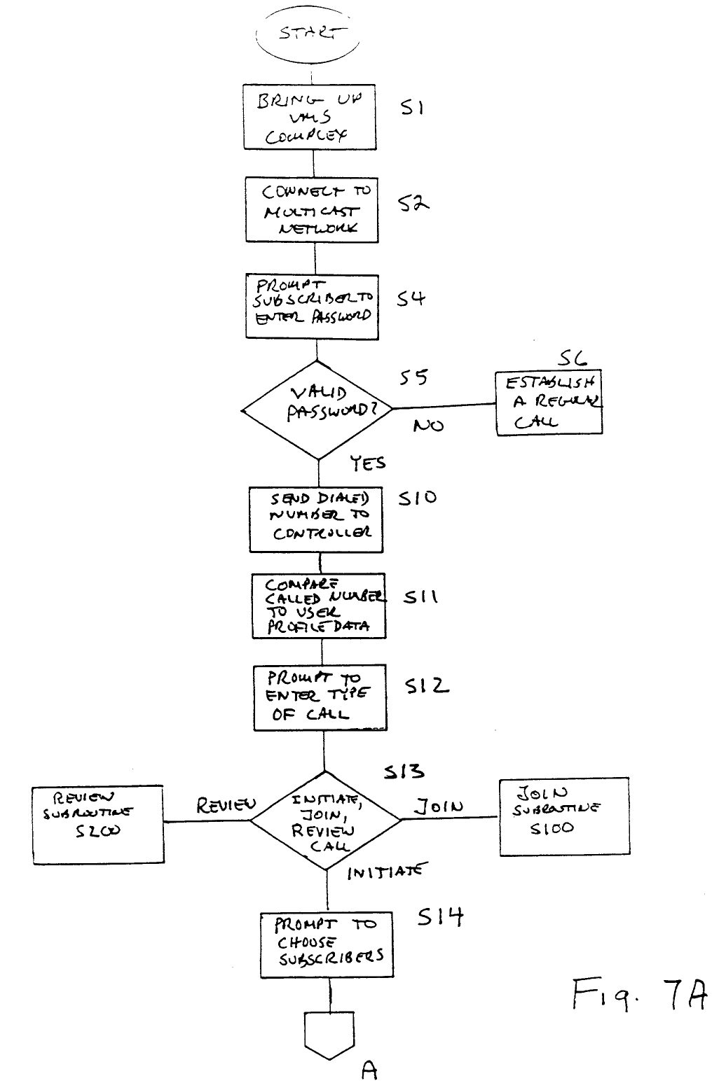

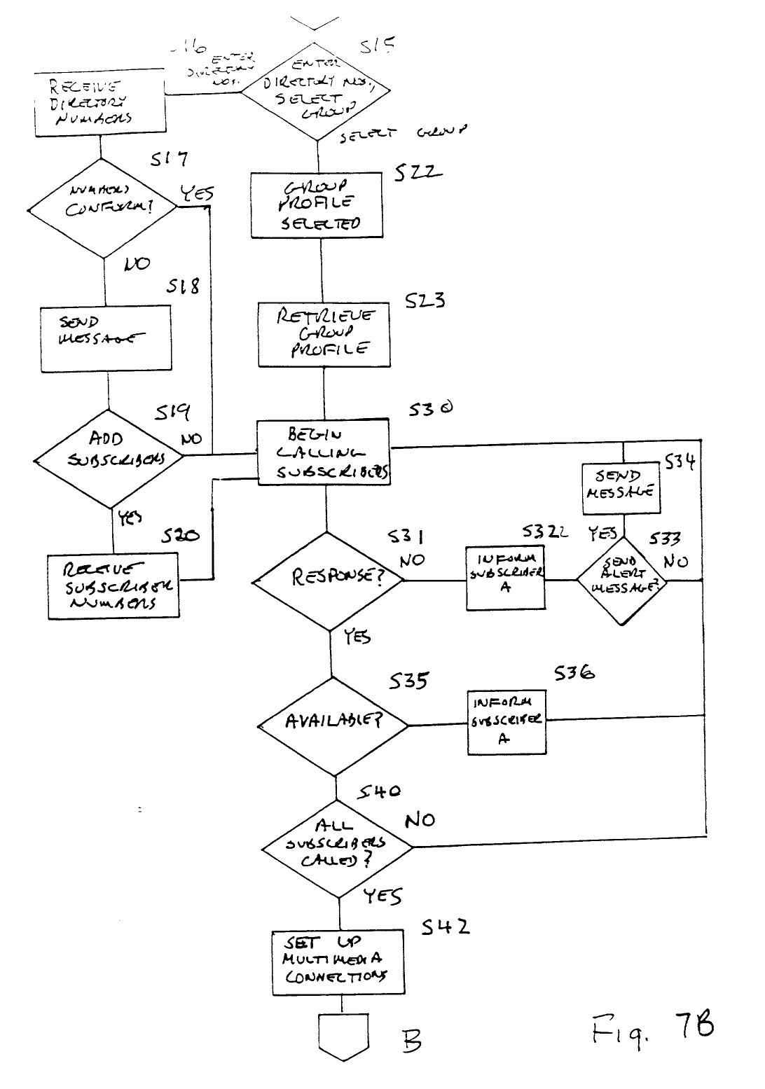

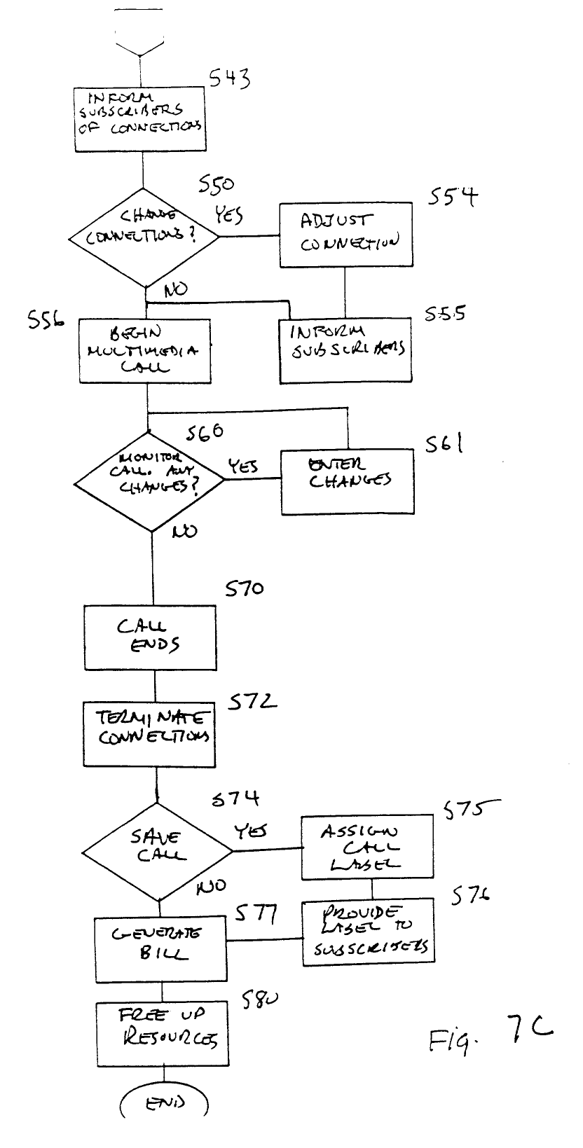

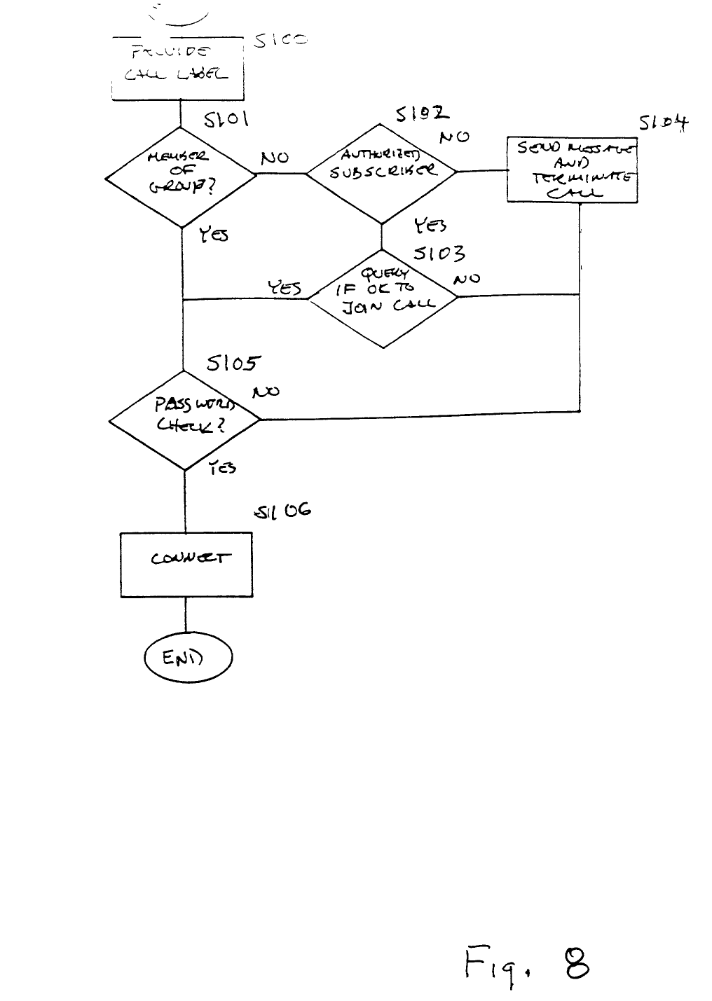

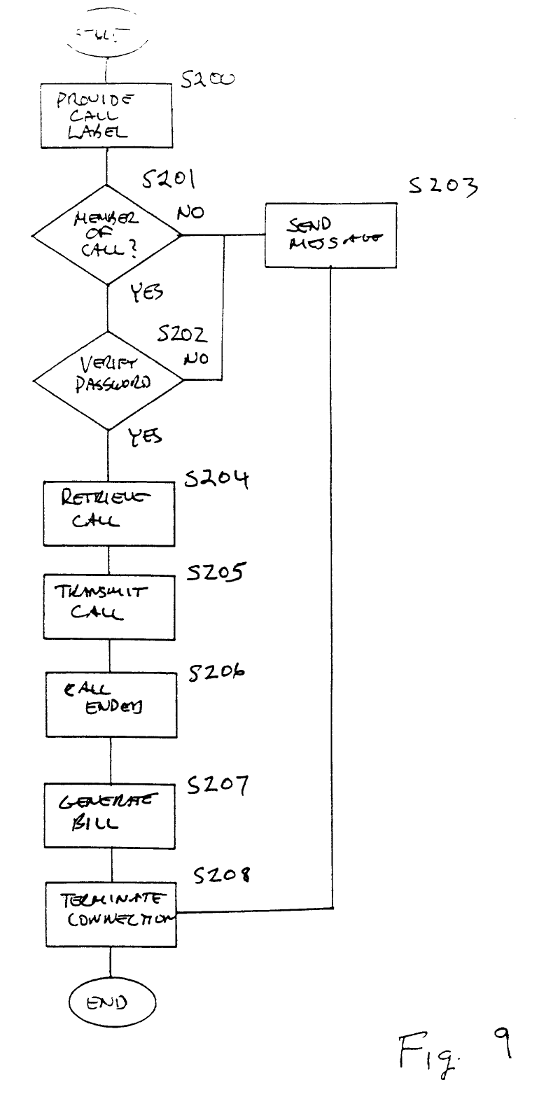

FIG. 4 shows more details of the multicast network 10. The multicast network 10 may include a number of nodes for completing multimedia calls between subscribers connected to the multicast network 10. The multicast network 10 may also contain at least one virtual meeting services complex 100 associated with at least one of the nodes. The virtual meeting services complex 100 provides additional multimedia services for subscribers connected to the multicast network 10.

The multimedia call between at least two multimedia service subscribers may be created by first receiving a call from a calling party, such as subscriber A, to the virtual meeting services complex 100 in the multicast network 10. The virtual meeting services complex 100 may then create one or more virtual meeting rooms in response to receipt of the call from subscriber A. Details of the virtual meeting room are provided in pending U.S. patent application 08/051,724, filed on Apr. 22, 1993, which is hereby incorporated by reference.

The multimedia call may also be initiated by the subscribers A-D calling in to a meet-me-bridge (not shown). Alternately, the multimedia call may be initiated by the multicast server 11 placing a call to the subscribers A-D.

Subscriber A may access the virtual meeting services complex 100 by dialing a toll free number, such as an 800 number, associated with the virtual meeting services complex 100 using the telephone 49 shown in FIG. 2. Subscriber A may also access the virtual meeting services complex by logging on using the computer 40 shown in FIG. 2. The virtual meeting services complex 100 may prompt subscriber A to supply certain information in response to receipt of the telephone call or log-on, such as information about subscribers B-D and information to authenticate subscriber A.

Alternately, subscriber A can create a multimedia call in which only subscriber A and the virtual meeting services complex 100 are connected. This situation may occur, for example, when subscriber A chooses to access a multimedia call that has been saved in the multicast network 10.

The multicast network 10, as shown in FIG. 4, may include a number of distinct network components. The multicast network 10 may contain a public switched long distance telephone network (e.g., plain old telephone service (POTS)) composed of a number of interconnected network nodes 120 and 121, each having a switching system. The multicast network 10 may also contain one or more packet networks such as a frame relay data network composed of a number of interconnected frame relay nodes 123 and 124 and an ATM network composed of a number of interconnected ATM nodes 125 and 126. Although an asynchronous packet network such as an ATM network is shown in FIG. 4, synchronous packet networks such as those using the synchronous hierarchy (SDH) or the synchronous optical network (SONET) standards may also be in the multicast network 10. In general, all electrical, electro-optical, or all-optical networks can be used in the multicast network 10.

In FIG. 4, the circuitry to form the virtual meeting room for subscribers A-D in the multicast network 10 is shown as a centralized complex connected to the multicast server 11. Alternately, the virtual meeting services circuitry may be distributed over a number of different pieces of equipment in the multicast network 10, as appropriate. Each component of the virtual meeting services circuitry does not need to have the same capabilities as the others. There also may be virtual meeting services capability programmed into any node in the multicast network 10. FIG. 4 shows a virtual meeting services capability in a long distance network. However, the virtual meeting services capability may also be associated with any one or more of the nodes of a local network or with a node in a customer premises network or other private telecommunications network.

The virtual meeting services complex 100 shown in FIG. 4 either contains or is able to access media bridges that can provide the connections among subscribers involved in the multimedia call using the multicast network 10. The media bridges include audio bridges 136-139, video bridges 140-143 and data bridges 144-147. Thus, the virtual meeting services complex 100 can access the multicast server 11 as well as audio bridges that may be used to complete the audio portion of the multimedia call. The activities of the bridges used in each conference are coordinated by respective media servers 150-152. Alternately, the multicast server 11 may include an audio bridge (not shown), for example. The media bridges may be separate devices accessed by the media servers as shown in FIG. 4 or the media bridges may be integral parts of the media servers, such as software entities programmed into computers which perform the server functions. The virtual meeting services complex 100 may also contain one or more devices such as a storage device 128 for storing certain predetermined aspects of the calls held through the virtual meeting services complex 100, such as connection features, and for storing information related to the subscribers, such as group identifiers and individual subscriber equipment capabilities.

The virtual meeting services complex 100 may also contain one or more subcontrollers such as subcontroller 130 that control the multimedia call and that provide special features for subscribers of the virtual meeting service. In particular, the subcontroller 130 may establish a virtual meeting room.

FIG. 5 shows some of the features of a virtual meeting room, such as virtual meeting room 160. The virtual meeting room 160 may contain various displays such as a call label display 161, a call status display 162 and a writing board 163. The subcontroller 130 may control entries in the writing board 163. For example, if subscriber A requests the writing board feature, the subcontroller 130 creates a specific virtual space in the virtual meeting room 160. The writing board 163 is then communicated to the subscribers A-D. Then, subscriber A, for example, may make entries in the virtual writing board 163 that can be observed by subscribers B-D. The network writing board feature thus simulates an actual writing board that might be used in a face-to-face conference. In addition, the information entered on the writing board 163 may be saved as part of the virtual meeting room 160 in the storage device 128.

The special features provided by the subcontroller 130 may include a subconferencing function that allows a subset of the subscribers, such as subscribers A and B, to break away from the other subscribers (i.e., subscribers C and D) and to confer privately with each other or with one or more outsiders, without subscribers C and D being able to participate in the subconference. The subcontroller 130 may provide a signaling function that allows a subscriber to signal his desire to enter or reenter a call. Thus, if subscriber C, for example, leaves the multimedia call, he can rejoin the multimedia call by signaling his intention using the keyboard 41, for example. These features related to the multimedia call may be displayed in the call status display 162.

The subcontroller 130 may also provide a call review feature whereby the past history of a multimedia call that is stored in the storage device 128 and may be played back to subscribers of the virtual meeting service. The subcontroller 130 can control the storage device 128 to store a multimedia call for an indefinite period of time, at the discretion of the subscriber responsible for the multimedia call. For example, subscriber A can direct the subcontroller 130 to save the multimedia call for one year. The subcontroller 130 will assign the multimedia call a label, which in a virtual sense corresponds to a room number of an actual meeting room, and will store the multimedia call in the storage device 128. In FIG. 5, the virtual meeting room 160 is associated with the in-progress multimedia call label 160A, which is displayed in the call label.

In FIG. 4, the storage device 128 is shown storing a multimedia call that has an associated label 160A. All the multimedia call participants (i.e., subscribers A-D) may be provided with this label, and to access the multimedia call, can simply enter the label 160A when prompted by the subcontroller 130 or may highlight the label in an access window using the keyboard 41 or the mouse 42, for example. The subscriber would then be connected to the multimedia call associated with the label 160A if the multimedia call were in progress. Further, any of the subscribers A-D who are authorized access to the multimedia call can, as long as the multimedia call 160A is saved in the storage device 128, access the saved contents of the multimedia call, i.e., virtual meeting room 160, by connecting to the multicast network 10 in the normal manner for placing a multimedia call and then selecting the label 160A when prompted by the subcontroller 130.

The subcontroller 130 may provide a service selection feature that allows subscribers to elect different types or grades of service. For example, subscriber A may want to transmit video signals at a frame rate other than 30 fps. Subscriber A can signal the subcontroller 130 of this desire before or during the multimedia call by using the keyboard 41, for example. However, the multicast server 11 may transmit the video signal from subscriber A to subscribers B-D at a predetermined frame rate (e.g., 30 fps).

The multicast server 11 may allow the subscribers A-D to receive a composite video signal at a reduced bandwidth. That is, if subscriber B, for example, was connected to the multicast network 10 by a POTS line, but without an ADSL connection, subscriber B could still receive a video presentation of subscribers A, C and D on the display 44. In this case, the multicast server 11 sends three video streams to subscriber B's POTS endpoint, and the three video signals are displayed on the display, but at a reduced bandwidth.

The multicast server 11 may provide for receipt and transfer of both compressed and uncompressed signals. For example, each subscriber A-D may elect to send data in a compressed format. Alternately, the multicast server 11 may cause all the signals received at the multicast network 10 to be compressed by the same value.

In addition to storing multimedia calls, the storage device 128 can store information concerning subscribers A-D. For example, subscribers A-D could constitute a group and be assigned a unique group identifier. The group identifier, along with the directory numbers of each of the subscribers A-D could be stored in the storage device 128. Other information can be associated with the group identifier, such as equipment capabilities (e.g., subscriber B has a MacIntosh computer) and default connection conditions (e.g., connect subscriber B at a video frame rate of 20 frames per second) for each of the subscribers A-D. Then, connecting to the multicast network 10, subscriber A can direct the subcontroller 130 to establish a multimedia call to the group comprising subscribers A-D by simply entering the group identifier when prompted by the subcontroller 130. This feature for establishing the multimedia call makes call initiation simple to execute for subscriber A.

FIG. 6 shows an alternate arrangement of a multicast network 200 for providing high quality multimedia according to the invention. In FIG. 6, subscribers B-D are shown connected through the multicast network 200 and a multicast server 240. The multicast network 200 includes an audio bridge 210 for transmitting audio signals. Subscribers C and D are connected through LAN connections 220 and routers (not shown) for transmitting video and data communications. Subscriber B uses the ADSL connector 230 to receive and transmit audio, video, and digital communications.

The audio bridge 210 may be one or more plain old telephone service (POTS) bridges 212 which receive POTS signals from subscribers and direct selected ones of those POTS signals to preselected subscribers. Similarly, there may be one or more ISDN bridges 213 and ATM bridges 214 that perform similar functions with ISDN and ATM audio signals produced by the subscribers B-D. The group of audio bridges may also contain one or more hybrid bridges 215 that receive different kinds of signals from subscribers using POTS devices and signals from subscribers using ISDN devices. The hybrid bridges are capable of converting audio signals of one type into audio signals of another type so that subscribers using dissimilar equipment may be able to communicate with one another. For example, the hybrid bridge 215 may: 1) receive POTS audio from a POTS telephone subscriber; 2) convert the POTS audio to the ISDN format; and 3) transmit signals in the ISDN format to subscribers using ISDN equipment, and vice versa. In FIG. 5, the audio signals are transmitted through one or more of the audio bridges 210, but are not multicast. However, other multimedia signals from subscriber B can be multicast through the multicast server 240 to subscribers C and D.

Subscribers C and D transmit multimedia video and data signals between themselves using the LAN connections 220, and transmit audio signals using the audio bridge 210. Subscribers C and D can also transmit multimedia video and data to subscriber B through the ADSL connection 230.

Returning to FIGS. 1 and 2, the multimedia call is created between two or more subscribers when a calling party places a call to the multicast network 10. The multicast network 10 can receive a directory number of one or more called parties from the calling party. Alternately, the calling party can establish a predetermined group that is automatically called to establish the multimedia call. Finally, the multimedia call can be created between a calling party and the virtual meeting services complex 100. In this last example, the calling party would access the data storage device 128 to review the contents of a stored multimedia call.

When the multicast network 10 receives the directory number of one or more called parties from the calling party, the multicast network 10 determines whether the calling party and at least one called party are subscribers to the multimedia services offered by the multicast network 10. The multicast network 10 connects the calling party and the called parties to a multimedia node, such as node 125 in the multicast network 10. The node is connected to a multicast server such as the multicast server 11. A connection having predefined characteristics is created among the subscribers. The connection may comprise one or more of a number of multiple media connections such as one or more audio, video, and data connections. The predefined characteristics of the connection can include a certain amount of bandwidth allocated to the call so that communications in the selected media may be accommodated. The predefined characteristics of the connections may be stored as default characteristics in a group profile. A subscriber to the multimedia service may communicate desired default characteristics to the multicast network 10 when subscription to the service is initiated or during the course of a call between subscribers in response to prompts from the multicast network 10 at call setup.

FIGS. 7A-9 are flowcharts representing the process of establishing and completing a multimedia call in accordance with the multicast network shown in FIG. 1. For purposes of illustration, the description of the multimedia call process assumes that subscriber A initiates multimedia call to the multicast network 10 in FIG. 1 to communicate with subscribers B-D. However, the multimedia call could also be initiated by the subscribers A-D calling to a meet-me-bridge or by the multicast server 11 calling the subscribers A-D.

In step S1, subscriber A initially brings up the virtual meeting services complex on the computer 40 and the process moves to step S2. In step S2, the multicast server 11 establishes a connection between subscriber A and the multicast network 10 through the ADSL connection 1 and signal line 20. This connection can be established by the subscriber A through the computer 40, for example. Alternately, the connection may be established by the subscriber A dialing the telephone number, for example, a toll free number such as an 800 number. The process then moves to step S4. In step S4, once the call has been received at the multicast network 10 and the connection between subscriber A, the computer 40, and the multicast network 10 has been established, security procedures that authenticate subscriber A as an authorized multimedia subscriber are performed. These security measures may be in the form of the multicast server 11 requesting or prompting subscriber A to enter a password which is then checked against a list of authorized passwords stored in the storage device 128. The process then moves to step S5. In step S5, if the multicast server 11 determines that subscriber A is not an authorized subscriber, the process moves to step S6. Otherwise, the process moves to step S10. In step S6, the multicast server 11 proceeds to establish a regular telephone call.

In step S10, the multicast server 11 sends the dialed telephone number to the subcontroller 130 in the virtual meeting services complex 100. The process then moves to step S11. In step S11, the subcontroller 130 compares the called number to group profile data stored in the storage device 128. The group profile may contain information about which media subscriber A is capable of using, for example. The process then moves to step S12.

In step S12, the subcontroller 130 prompts subscriber A to indicate which type of multimedia connection to make. The process then proceeds to step S13. In step S13, the subcontroller receives the input from subscriber A. If in step S13, subscriber A indicates to initiate a multimedia call, the process moves to step S14. If subscriber A indicates to join an existing multimedia call, the process moves to step S100 and executes a join subroutine. If subscriber A indicates to review a stored multimedia call, the process moves to step S200 and executes a review subroutine.

In step S14, the subcontroller 130 prompts subscriber A to enter directory numbers of the called parties or to elect to connect to a predetermined group with directory numbers stored in the storage device 128. The process then moves to step S15. In step S15, the subcontroller 130 receives subscriber A's input. In step S15, if enter directory numbers is elected, the process moves to step S16; if connect to a predetermined group is elected, the process moves to step S22.

In step S16, the subcontroller 130 receives the directory numbers for the called parties selected by subscriber A. The process then moves to step S17. In step S17, the subcontroller 130 compares the directory numbers input in step S16 to directory numbers stored in the storage device 128. If in step S17, any of the directory numbers entered in step S16 do not correspond with those stored in the storage device 128, the process moves to step S18. If all the directory numbers entered in step S16 correspond to directory numbers in the storage device 128, the process moves to step S30.

In step S18, the subcontroller 130 sends a message to subscriber A indicating which of the directory numbers do not correspond to directory numbers in the storage device 128. The process then moves to step S19. In step S19, the process queries subscriber A to ask if subscriber A desires to add any of the non-corresponding directory numbers to the multimedia call. In step S19, if subscriber A indicates to add any of the non-corresponding directory numbers to the multimedia call, the process moves to step S20. In step S19, if subscriber A indicates not to add the non-corresponding directory numbers to the multimedia call, the process moves to step S30. In step S20, the subcontroller 130 receives the input from subscriber A. Subscriber A indicates his input by highlighting the non-corresponding directory numbers, for example. The process then proceeds to step S30.

In step S22, subscriber A selects a group profile by which the multimedia connections are established. The process proceeds to step S23. In step S23, the subcontroller 130 retrieves the group profile from the storage device 128. The process then proceeds to step S30.

In step S30, the subcontroller 130 begins calling the directory numbers, by dialing the first directory number on the list. The process then moves to step S31. In step S31, the process waits for a response from the directory number. In step S31, if the subcontroller 130 receives no response, as indicated by the no interruption in ringing, for example, the process moves to step S32. In step S32, the subcontroller 130 indicates to subscriber A that a called directory number received no response. The process then moves to step S38 and queries subscriber A if an alerting message should be sent. If no alerting message is to be sent, the process returns to step S30. If an alerting message is to be sent, the process moves to step S34. In step S34, the subcontroller 130 sends a message to a message box (i.e., a text message that is stored in a memory of the computer 40) corresponding to the non-responding directory number, for example. The message can also be an audio message that is played when subscriber B next uses his computer 40. The message to subscriber B indicates that subscriber A is attempting to establish a multimedia call. The process then moves to step S30.

In step S31, if the subcontroller 130 receives a response, the process moves to step S35. In step S35, the subcontroller 130 queries subscriber B to determine if subscriber B is available to participate in the multimedia call.

Subscriber B indicates availability to participate in the multimedia call by using an input device such as the keyboard 41 or the mouse 42 of the computer 40, for example. In step S35, if subscriber B is not available, the process moves to step S36. Otherwise the process moves to step S40. In step S36, the subcontroller 130 provides an indication to subscriber A that subscriber B is not available. The process then returns to step S30.

In step S40, the subcontroller 130 determines if all the called parties (i.e., subscribers B-D) provided by subscriber A have been called. In step S40, if all the subscribers B-D have not been called, the process returns to step S30. Otherwise, the process moves to step S42.

In step S42, the multicast server 11 sets up multimedia connections between the subscribers A-D that are available for the multimedia call. In establishing the multimedia connections, the multicast server 11 may refer to the group profile provided by subscriber A at step S22. For example, the group profile may contain information that subscriber B does not have the ability to send video, but can receive video. Accordingly, the multicast server 11 will only establish a downstream video connection for subscriber B. Further, the group profile may indicate that certain subscribers are to be automatically connected in all media, or that only some of the subscribers are to be connected by all media and that other subscribers are to be connected by a subset of media capabilities. In step S42, if other than full multimedia connections are provided to and from each subscriber A-D, the process moves to step S43. Otherwise the process moves to step S50

In step S43, the subcontroller sends a message to each of the subscribers A-D indicating who among the subscribers has other than full multimedia connections. The message can be a simple text message displayed on the display 44 for each of the subscribers A-D. The process then moves to step S50.

In step S50, the subcontroller 130 queries if the subscribers A-D desire alternate multimedia connections. In step S50, if no subscriber desires alternate multimedia connections, the process moves to step S56. Otherwise, the process moves to step S54. In step S54, the subcontroller 130 and the multicast server 11 adjusts the multimedia connections in accordance with the desires of the subscribers A-D. The process then moves to step S55. In step S55, the subcontroller 130 indicates to one or all the subscribers A-D what connections are not available for certain subscribers. The subcontroller 130 provides this indication as a simple text message displayed on the display 44 for each of the subscribers A-D, for example. The process then moves to step S56.

In step S56, the multicast server 11 begins the multimedia call. The process then moves to step S60.

In step S60, the subcontroller 130 monitors the progress of the multimedia call. In step S60, if the subcontroller 130 determines there are any changes, such as changing a video frame rate, the process moves to step S61. In step S61, the subcontroller 130 receives inputs from the subscribers and enters the changes. The process then moves to step S70.

In step S70, the subcontroller 130 determines that the multimedia call has ended. The subcontroller 130 determines that the multimedia call has ended when all subscribers have signed off or gone on-hook. The process then moves to step S72. In step S72, the multicast server 11 terminates connections in all media. The process then moves to step S74. In step S74, the subcontroller 130 prompts subscriber A to save the results of the multimedia call. In step S74, if subscriber A does not desire to save the results of the multimedia call, as indicated by subscriber A selecting a do not save option, the process moves to step S77. Otherwise the process moves to step S75. In step S75, the subcontroller 130 assigns a unique label to the multimedia call and saves the results of the multimedia call in the storage device 128. The process then moves to step S76. In step S76, the subcontroller 130 provides the multimedia call label to subscriber A. The process then moves to step S77. In step S77, the subcontroller 130 generates a billing statement for the multimedia call. The process then moves to step S80. In step S80, the multicast server 11 frees up all resources.

FIG. 8 shows the method of connecting a subscriber, such as subscriber A, to an existing multimedia call. In step S100, subscriber A provides the label for the virtual meeting room corresponding to multimedia call, such as the virtual meeting room 160, for example. The process then moves to step S101. In step S101, the subcontroller 130 determines if subscriber A is a member of the group using the virtual meeting room 160. If subscriber A is a member of the group, the process moves to step S105. Otherwise the process moves to step S102.

In step S102, the subcontroller 130 determines if subscriber A is a subscriber to the multimedia service. If subscriber A is a subscriber to the multimedia service, the process moves to step S103. Otherwise the process moves to step S104.

In step S104, the subcontroller 130 sends a message to subscriber A indicating that connection is not authorized and terminates the call.

In step S103, the subcontroller 130 queries the subscriber connected to the virtual meeting room 160 if subscriber A may join the multimedia call. In step S103, if the subscribers answer no, the process moves to step S104 and the subcontroller 130 terminates the call as described above. In step S103, if the subscriber answers yes, the process moves to step S105.

In step S105, the subcontroller prompts subscriber A to enter a password and compares the entered password to a password stored in the storage device 128 for subscriber A. If the password is incorrect, the process moves to step S104 and the subcontroller 130 terminates the call as described above. If the password is correct, the process moves to step S106 and the subcontroller 130 connects subscriber A to the virtual meeting room 160.

FIG. 9 shows a method for connecting a subscriber, such as subscriber A, to a stored multimedia call. In step S200, subscriber A provides the label 160A corresponding to the stored multimedia call, or virtual meeting room 160. The process then moves to step S201.

In step S201, the subcontroller 130 determines if subscriber A is a member of the group connected to the virtual meeting room 160. If subscriber A is a member of the group, the process moves to step S202. Otherwise the process moves to step S203.

In step S202, subscriber A enters a password that is verified by subcontroller 130 comparing the entered password to a password stored in the storage device 128. If the password is correct, the process moves to step S204, otherwise the process moves to step S203.

In step S203, the subcontroller sends a message to subscriber A indicating that access to the virtual meeting room 160 is denied. The process then moves to step S208.

In step S204, the subcontroller 130 retrieves the virtual meeting room 160 from the storage device 128. The process then moves to step S205. In step S205, the multicast server 11 transmits the contents of the virtual meeting room 160 to subscriber A. The process then moves to step S206.

In step S206, the subcontroller 130 receives a signal to terminate the virtual meeting room 180. The process then moves to step S207 and the subcontroller 130 generates billing information. The process then moves to step S208. In step S208, the subcontroller 130 terminates the virtual meeting room 180 and stores its contents in the storage device 128.

In the illustrated embodiment, suitably programmed general purpose computers control data processing in the multicast network 10. However, the processing functions could also be implemented using a single purpose integrated circuit (e.g., an ASIC) having a main or central processor section for overall, system-level control, and separate circuits dedicated to performing various specific computational, functional, and other processes under control of the central processor section. The processing can also be implemented using separate dedicated or programmable integrated electronic circuits or devices (e.g., hardwired electronic or logic devices). In general, any device or assembly of devices on which a finite state machine capable of implementing the flowchart of FIGS. 7A-9 can be used to control data processing.

The invention has been described with reference to the preferred embodiments thereof, which are illustrative and not limiting. Various changes may be made without departing from the spirit and scope of the invention as defined in the following claims.

What is claimed is:

1. A method for providing multimedia communications including audio, video, and data communications, comprising:
receiving multimedia communications from a first party in a multimedia communications device using a first bandwidth; and
transmitting multimedia communications from the multimedia communications device to the first party at a second bandwidth greater than the first bandwidth.

2. The method of claim 1, further comprising:
receiving multimedia communications from a second party in the multimedia communications device using the first bandwidth; and
multicasting the multimedia communications received from the first party and the second party, wherein the first party and the second party receive the multimedia communications using the second bandwidth.

3. The method of claim 2, further comprising:
receiving multimedia communications from a third party at the first bandwidth;
reducing bandwidths of the multimedia communications from the first and the second parties to produce a reduced bandwidth signal less than or equal to the first bandwidth; and
transmitting the reduced bandwidth signal to the third party.

4. The method of claim 2, wherein the first bandwidth is at least about 640 kilobits per second and the second bandwidth is at least about 6 megabits per second.

5. The method of claim 2, further comprising the step of prompting parties to indicate desired multimedia connections to complete the multimedia communications.

6. A method of creating a first multimedia call between at least two parties, comprising:
connecting the at least two parties to a multicast services node in a multicast network; and
receiving multimedia communications from the at least two parties at a first bandwidth and multicasting the multimedia communications to each of the at least two parties at a second bandwidth greater than the first bandwidth.

7. The method of claim 6, wherein the first bandwidth is at least about 640 kilobits per second and the second bandwidth is at least about 6 megabits per second.

8. The method of claim 6, further comprising creating a second multimedia call in simultaneous operation with the first multimedia call, wherein one or more of the at least two parties participates in the second multimedia call.

9. The method of claim 8, wherein the connection comprises one or more of a plurality of multimedia connections.

10. The method of claim 9, wherein the multimedia includes at least two of audio, video, and data.

11. The method of claim 10, further comprising:
multicasting the received video and data multimedia communications; and
transmitting the received audio communications via an audio bridge.

12. The method of claim 11, wherein two or more of the at least two parties transmit multimedia communications using a local area network.

13. The method of claim 12, wherein at least one of the at least two parties transmit compressed audio communications.

14. The method of claim 13, further comprising the step of automatically identifying capabilities of communications equipment of the at least two parties.

15. The method of claim 14, further comprising saving the multimedia call in the multicast network.

16. An apparatus providing multimedia communications to subscribers of a multimedia service, comprising:
a multimedia communications device for receiving multimedia communications from the subscribers and for multicasting the multimedia communications to the subscribers; and
connectors coupled to communications devices of the subscribers and the controller, the connectors allowing transmission of the multimedia communications from the subscribers at a first bandwidth and reception of the multimedia communications by the subscribers at a second bandwidth equal to or greater than the first bandwidth.

17. The apparatus of claim 16, wherein the first bandwidth is about 640 kilobits per second and the second bandwidth is about 6 megabits per second.

18. The apparatus of claim 16, wherein the connectors of two or more of the subscribers are local area network connectors.

19. The apparatus of claim 16, wherein the controller further comprises an audio bridge for transmitting and receiving audio communications from the subscribers.

20. The apparatus of claim 16, wherein the multimedia communications includes at least two of audio, video and data communications.

21. The apparatus of claim 16, wherein the controller reduces bandwidths of the received multimedia communications and combines the reduced bandwidths to produce a third bandwidth signal, the third bandwidth being less than or equal to the first bandwidth, the third bandwidth signal being transmitted to one or more of the subscribers.
